(19) United States
(12) Patent Application Publication
(10) Pub. No.: US 2026/0368858 A1
(43) Pub. Date: Nov. 19, 2026

(54) IMAGE ENHANCEMENT SYSTEM AND IMAGE ENHANCEMENT METHOD FOR BLOOD CELL IMAGES

(71) Applicant: MING CHI UNIVERSITY OF TECHNOLOGY, New Taipei City (TW)

(72) Inventors: Ngoc Tuyen Le, New Taipei City (TW); Jin-Wei Liang, New Taipei City (TW)

(21) Appl. No.: 19/325,517

(22) Filed: Sep. 11, 2025

(30) Foreign Application Priority Data
May 19, 2025 (TW) 114118585

(51) Int. Cl. G06T 5/50; G06T 5/92

(52) U.S. Cl. CPC G06T 5/50; G06T 5/92; G06T 2207/10024; G06T 2207/20212

(57) ABSTRACT

An image enhancement system and an image enhancement method for blood cell images. The image enhancement method includes decomposing the blood cell image to be processed into first color channel images corresponding to color channels; performing a conversion procedure to obtain first frequency domain information and second frequency domain information; retrieving first direct-current (DC) characteristic information from the first frequency domain information, and retrieving a second DC characteristic information from the second frequency domain information, respectively; performing a decomposition procedure to obtain first brightness characteristic information and second brightness characteristic information; performing a brightness compensation procedure on the first brightness characteristic information in the first DC characteristic information to obtain compensated DC characteristic information; restoring the compensated DC characteristic information to obtain second color channel images respectively corresponding to the color channels; and combining the second color channel images to generate an enhanced blood cell image.

### CROSS-REFERENCE TO RELATED PATENT APPLICATION

This application claims the benefit of priority to Taiwan Patent Application No. 114118585, filed on May 19, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to an image enhancement system and an image enhancement method for blood cell images.

### BACKGROUND OF THE DISCLOSURE

Although the application of deep learning models to blood cell recognition has achieved positive results, machine-based blood cell recognition still faces many challenges. One of the main challenges is the high variability and complexity of blood cell images.

Blood cell images may vary in quality, resolution, contrast, illumination, staining, and background. Furthermore, blood cells may vary significantly in shape, size, color, texture, and distribution. Moreover, blood cells may overlap with each other, aggregate, or deform, which brings challenges to their segmentation and identification processes.

### SUMMARY OF THE DISCLOSURE

In response to the above-referenced technical inadequacies, the present disclosure provides an image enhancement system and an image enhancement method for blood cell images capable of improving on the quality of the blood cell images in a preprocessing procedure.

In order to solve the above-mentioned problems, one of the technical aspects adopted by the present disclosure is to provide an image enhancement system for blood cell images. The image enhancement system includes a processing device configured to perform the following procedures on a blood cell image to be processed: decomposing the blood cell image to be processed into a plurality of first color channel images corresponding to a plurality of color channels; performing a conversion procedure on the plurality of first color channel images and a predetermined brightness distribution of the blood cell image to be processed to obtain a plurality of first frequency domain information and second frequency domain information; retrieving a plurality of first direct-current (DC) characteristic information from the plurality of first frequency domain information, and retrieving a second DC characteristic information from the second frequency domain information, respectively; performing a decomposition procedure on the plurality of first DC characteristic information and the second DC characteristic information to obtain a plurality of first brightness characteristic information and second brightness characteristic information; based on the plurality of first color channel images, the plurality of first DC characteristic information, the plurality of first brightness characteristic information, and the second brightness characteristic information, performing a brightness compensation procedure on the first brightness characteristic information in the plurality of first DC characteristic information to obtain a plurality of compensated DC characteristic information; restoring the plurality of compensated DC characteristic information to a plurality of compensated frequency domain information, and performing an inverse conversion procedure on the plurality of compensated frequency domain information to obtain a plurality of second color channel images respectively corresponding to the plurality of color channels; and combining the plurality of second color channel images to generate an enhanced blood cell image.

In order to solve the above-mentioned problems, another one of the technical aspects adopted by the present disclosure is to provide an image enhancement method for blood cell images. The image enhancement method includes configuring a processing device to perform the following procedures on a blood cell image to be processed: decomposing the blood cell image to be processed into a plurality of first color channel images corresponding to a plurality of color channels; performing a conversion procedure on the plurality of first color channel images and a predetermined brightness distribution of the blood cell image to be processed to obtain a plurality of first frequency domain information and second frequency domain information; retrieving a plurality of first direct-current (DC) characteristic information from the plurality of first frequency domain information, and retrieving a second DC characteristic information from the second frequency domain information, respectively; performing a decomposition procedure on the plurality of first DC characteristic information and the second DC characteristic information to obtain a plurality of first brightness characteristic information and second brightness characteristic information; based on the plurality of first color channel images, the plurality of first DC characteristic information, the plurality of first brightness characteristic information, and the second brightness characteristic information, performing a brightness compensation procedure on the first brightness characteristic information in the plurality of first DC characteristic information to obtain a plurality of compensated DC characteristic information; restoring the plurality of compensated DC characteristic information to a plurality of compensated frequency domain information, and performing an inverse conversion procedure on the plurality of compensated frequency domain information to obtain a plurality of second color channel images respectively corresponding to the plurality of color channels; and combining the plurality of second color channel images to generate an enhanced blood cell image.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an image enhancement system for blood cell images according to one embodiment of the present disclosure;

FIG. 2 is a flowchart of an image enhancement method for blood cell images according to one embodiment of the present disclosure;

FIG. 3 shows an original white blood cell image (top image) and a reconstructed white blood cell image (bottom image) using only low-frequency coefficients and setting remaining DCT coefficients to zero;

FIG. 4 is a detailed flowchart of step S14;

FIG. 5 sequentially shows a basophil image of a Raabin-WBC dataset, the basophil image of the Raabin-WBC dataset processed by the image enhancement method of the present disclosure, a basophil image of a PBC_dataset_normal_DIB dataset, and the basophil image of the PBC_dataset_normal_DIB dataset processed by the image enhancement method of the present disclosure; and

FIG. 6 shows a plurality of WBC images with different backgrounds and images processed by the image enhancement method of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

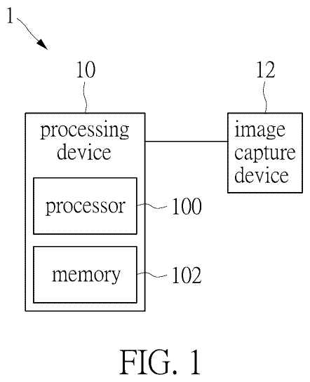

FIG. 1 is a functional block diagram of an image enhancement system for blood cell images according to one embodiment of the present disclosure. Referring to FIG. 1, one embodiment of the present disclosure provides an image enhancement system 1 for the blood cell images. The image enhancement system 1 may include a processing device 10 and an image capture device 12. The image capture device 12 may be used to capture the blood cell images, such as white blood cell images, and transmit data of the captured blood cell image to the processing device 10 for subsequent image processing and analysis. When used to capture the blood cell images, the image capture device 12 needs to have characteristics such as high resolution, high contrast, and high speed to quickly scan blood samples and identify cell structures. Therefore, the image capture device 12 may, for example, include a high-resolution optical microscope and a digital camera to digitize the blood cell images.

In blood cell images including white blood cells, the types of white blood cells may include lymphocytes, monocytes, neutrophils, basophils, and eosinophils. Determining the type and number of the white blood cells is crucial for diagnosing various diseases, and the white blood cells can be identified by nucleus, cytoplasm, and size. The shape and color of the nucleus and cytoplasm have a significant impact on determining the cell type. However, even in a same white blood cell image dataset, the colors between images of the same type of white blood cells are still inconsistent, and the background of the white blood cell images is also not uniform. Therefore, in order to more accurately determine the type of white blood cells, the quality of white blood cell images needs to be improved.

The processing device 10 may include a processor 100 and a memory 102 electrically connected to the processor 100. The processor 100 may be a central processing unit (CPU), a graphics processing unit (GPU), or an artificial intelligence processor (such as a TPU or an AI-specific accelerator) to process the blood cell images in real time and improve the accuracy of observation or subsequent diagnosis. The processing device 10 may perform procedures of denoising, contrast enhancement, edge enhancement, and super-resolution reconstruction to improve the visibility and recognition of microscopic blood cell structures (such as red blood cells, white blood cells, and platelets). The memory 102 may be used to temporarily store data, image files, and intermediate calculation results needed for program execution to support the operation of the processor 100. The memory 102 may be, for example, a random access memory (RAM), a flash memory, or an embedded multimedia card (eMMC).

In addition, the processing device 10 can also automatically classify blood cell types by identifying different blood cell types in the blood image, such as red blood cells (RBC), subtypes of white blood cells (WBC) (such as neutrophils, lymphocytes, monocytes, eosinophils, basophils) and platelets. The procedure of automatic classification generally includes procedures such as image capture, cell segmentation, characteristic capture, and classification. First, a blood smear image is captured through a digital microscope and undergoes preprocesses (such as noise removal and color adjustment), and then the image segmentation technology (such as a U-Net or a threshold manner) is used to separate the single cell from the background. After segmentation, characteristics such as shape, color, texture, can be captured from each of the cells, or the characteristics are directly input into a deep learning model (such as a convolutional neural network (CNN)) to automatically learn characteristics to distinguish red blood cells, platelets, and different types of white blood cells (such as lymphocytes and neutrophils).

In a classification procedure, the procedure can be performed through traditional machine learning methods (such as SVM and random forest) or end-to-end convolutional neural networks (such as ResNet and MobileNet). Deep learning models can effectively identify the shape of the cell nucleus, staining, and cytoplasmic structure, thereby improving classification accuracy.

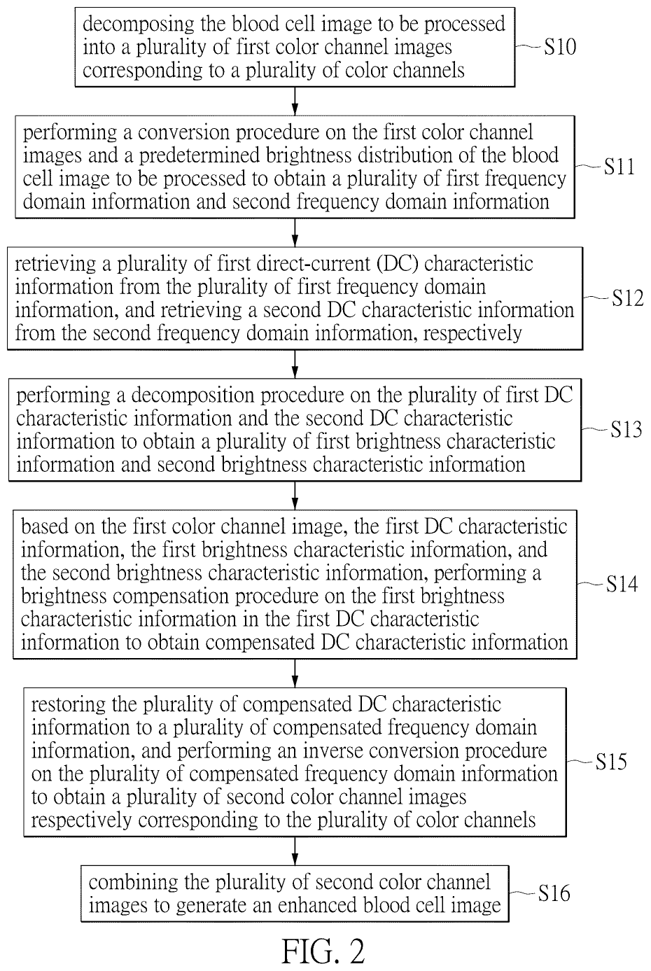

FIG. 2 is a flowchart of an image enhancement method for blood cell images according to one embodiment of the present disclosure. Referring to FIG. 2, the image enhancement method includes configuring a processing device 10 to obtain a blood cell image to be processed (such as a white blood cell image), and then executing the following steps:

Step S10 includes: decomposing the blood cell image to be processed into a plurality of first color channel images corresponding to a plurality of color channels.

In step S10, f may represent a fundus image (a colored image) to be processed, which is divided into three color channels W_{R}, W_{G}, and W_{B} in this step, respectively corresponding to red, green, and blue channels.

The step can be expressed as follows:

[symbol]

_{c}←split( [symbol] ),c∈[R,G,B].

Here, split(W) may be such as a channel separation function built into openCV, and a returned value is a grayscale image of the corresponding color channel.

Step S11 includes: performing a conversion procedure on the first color channel images and a predetermined brightness distribution of the blood cell image to be processed to obtain a plurality of first frequency domain information and second frequency domain information.

Here, the predetermined brightness distribution is a Gaussian template of the blood cell image to be processed, the conversion procedure is a two-dimensional discrete cosine transform (DCT) procedure, the first frequency domain information is a plurality of first DCT coefficient matrices corresponding to the color channels, and the second frequency domain information is a second DCT coefficient matrix corresponding to the Gaussian template.

The step can be expressed as follows:

[symbol]

=2DDCT( [symbol] _{c}):

[symbol]

=2DDCT( [symbol] ).

Here, Dc is the first DCT coefficient matrix corresponding to a color channel C, and Dg is the second DCT coefficient matrix corresponding to the Gaussian template. For a white blood cell (WBC) image of size N×N, a general equation of the two-dimensional discrete cosine transform (2D-DCT) is defined as follows:

$$𝒟 ( u , v ) = α ( u ) α ( v ) {\sum }_{x = 0}^{N - 1} {\sum }_{y = 0}^{N - 1} 𝒲 ( x , y ) cos ( ( x , u ) ) \times cos ( ( y , v ) ,$$

$$for u , v = 1 , 2 , … , N - 1.$$

According to the cosine coefficient D(μ,ν), the white blood cell image W(x, y) can be obtained by calculation of the two-dimensional inverse discrete cosine transform (2D-IDCT):

$$𝒲 ( x , y ) = α ( u ) α ( v ) {\sum }_{u = 0}^{N - 1} {\sum }_{v = 0}^{N - 1} 𝒟 ( u , v ) cos ( ( x , u ) ) \times cos ( ( y , v ) ;$$

$$for x , y = 1 , 2 , … , N - 1.$$

Step S12 includes: retrieving a plurality of first direct-current (DC) characteristic information from the plurality of first frequency domain information, and retrieving a second DC characteristic information from the second frequency domain information, respectively.

In detail, DCT can divide an image into regions of different importance (or spectral sub-bands) that are related to image quality. DCT converts the spatial domain of a signal or image into the frequency domain. If the pixel values of adjacent pixels in the spatial domain of the image vary significantly, after DCT processing, the coefficient D(μ,ν) in the high-frequency (HF) region will be greater than the coefficients in the low-frequency (LF) and medium-frequency (MF) regions. On the other hand, when the variation among adjacent pixels is decreased, D(μ,ν) coefficient may be increased.

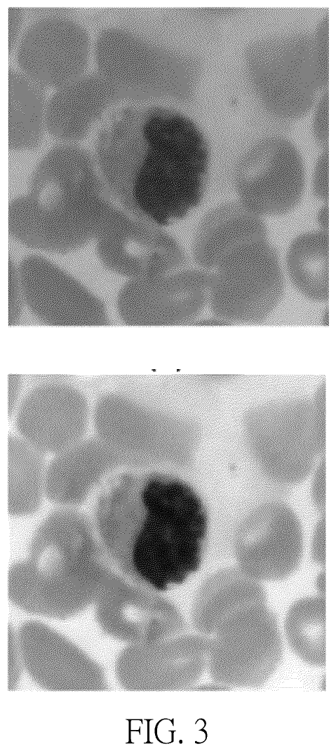

A first element of DCT is a direct current (DC) term, which is the mean value of the pixel values. The remaining elements of DCT are alternative current (AC) terms, which are independent of the mean value. Therefore, if the same value is added to all pixel values, only the DC term of DCT will change, while the AC terms remain unchanged. For most images, the signal energy is mainly concentrated in the low-frequency part. For example, the image reconstructed using low-frequency (LF) coefficients retains most of the key information. The DC coefficient is crucial to image processing, represents the average color or brightness of the image, and is similar to the “hue” (i.e., the overall brightness or brightness) in colored images. The DC coefficient reflects the overall intensity or brightness of the image. When adjusting the DC coefficient, in practice, the overall brightness or illumination of the image is modified. Referring to FIG. 3, FIG. 3 shows an original white blood cell image (top image) and a reconstructed white blood cell image (bottom image) using only low-frequency coefficients and setting remaining DCT coefficients to zero. As shown in FIG. 3, uneven illumination distribution will lead to a decrease in image quality, which in turn affects the recognition accuracy of the white blood cell image. Therefore, the DC coefficient is crucial to improving image quality.

The DCT separates key information in an image from the less noticeable details. In particular, the DC coefficient represents the average color or brightness of the image. When adjusting the DC coefficient, the overall brightness or illumination of the image is modified.

In this step, the first DC characteristic information is a first DC coefficient extracted from the first DCT coefficient matrix, and the second DC characteristic information is a second DC coefficient extracted from the second DCT coefficient matrix.

Step S13 includes: performing a decomposition procedure on the plurality of first DC characteristic information and the second DC characteristic information to obtain a plurality of first brightness characteristic information and second brightness characteristic information.

In step S13, the decomposition procedure is a singular value decomposition procedure, a singular value decomposition (SVD) is performed on Dc and Dg, and the equation is as follows:

$${𝒟}_{c} = {ℒ}_{c} {𝒮}_{c} {ℛ}_{c}^{T} , c ∈ \{ R , G , B \} :$$

$${𝒟}_{𝒢} = {ℒ}_{𝒢} {𝒮}_{𝒢} {ℛ}_{𝒢}^{T} .$$

Here, [symbol] _{c} and

$${ℛ}_{c}^{T}$$

are left singular vector and right singular vector matrices respectively, and S_{c} is the singular value matrix (i.e., a diagonal matrix). [symbol] _{g} and

$${ℛ}_{g}^{T}$$

are left singular vector and right singular vector matrices respectively, and S_{g} is the singular value matrix (i.e., a diagonal matrix).

In step S13, the first brightness characteristic information is the first singular value matrix S_{c} decomposed from the first DCT coefficient matrix Dc, and the second brightness characteristic information is the second singular value matrix S_{g} decomposed from the second DCT coefficient matrix D_{g}. Singular values are crucial in an illumination component of the image and represent the scaling factor applied during the transformation procedure. Larger singular values correspond to the most important transformations in the image, and the largest singular value contains the key information in the image, contributing 99.72% to the energy of the original image.

Step S14 includes: based on the first color channel image, the first DC characteristic information, the first brightness characteristic information, and the second brightness characteristic information, performing a brightness compensation procedure on the first brightness characteristic information in the first DC characteristic information to obtain compensated DC characteristic information.

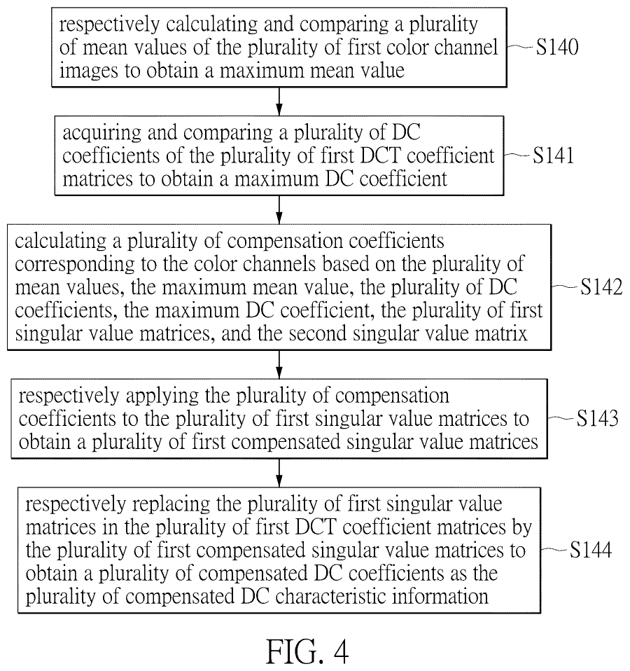

Referring to FIG. 4, FIG. 4 is a detailed flowchart of step S14. The brightness compensation procedure of step S14 includes processes as follows.

Step S140 includes: respectively calculating and comparing a plurality of mean values of the plurality of first color channel images to obtain a maximum mean value.

In the brightness compensation procedure of the embodiments of the present disclosure, the mean values of the plurality of color channels and the maximum mean value among the mean values are important factors in the spatial domain. Therefore, these values are calculated and included as part of the brightness compensation. The mean values of the plurality of color channels are calculated by the following equations:

$${μ}_{c} = \frac{1}{MN} {\sum }_{i = 0}^{M - 1} {\sum }_{j = 0}^{N} - 1 {𝒲}_{c} ( i , j ) ) ;$$

$${μ}_{max} = {max}_{c ∈ \{ R , G , B \}} ( {μ}_{c} ) .$$

Here, a size of the blood cell image to be processed is M*N, μ_{c} is the mean value of the first color channel image of the color channel C, and μₘₐₓ is the maximum mean value among the mean values of plurality of first color channel images.

Step S141 includes: acquiring and comparing a plurality of DC coefficients of the plurality of first DCT coefficient matrices to obtain a maximum DC coefficient.

Accordingly, when adjusting the DC coefficient, the overall brightness or illumination of the image are modified, such that the DC coefficient is included as part of the brightness compensation. By considering these DC coefficients and their maximum values, the illumination correction of the image can be achieved, and the image can have more uniform brightness, thereby improving the image enhancement effect. The maximum DC coefficient can be expressed as follows:

$${ω}_{max} = {max}_{c ∈ \{ R , G , B \}} ( {ω}_{c} ) .$$

Here, ω_{C} represents the DC coefficient of the first DCT coefficient matrix Dc of the color channel C, with c∈{R, G, B}. ωₘₐₓ is the maximum DC coefficient that can be used to adjust the brightness of the image to ensure the overall lighting balance.

Step S142 includes: calculating a plurality of compensation coefficients corresponding to the color channels based on the plurality of mean values, the maximum mean value, the plurality of DC coefficients, the maximum DC coefficient, the plurality of first singular value matrices, and the second singular value matrix.

In step S142, the compensation coefficient can be expressed as follows:

$${ζ}_{c} = \frac{{μ}_{max}}{{μ}_{c}} \times \frac{{ω}_{max}}{{ω}_{c}} \times \frac{max ( {𝒮}_{𝒢} )}{max ( {𝒮}_{c} )} .$$

Here, c is one of the color channels, ζ_{C} is the compensation coefficient of the corresponding color channel C, μ_{c} is the mean value corresponding to the color channel C, μₘₐₓ is the maximum mean value, ω_{c} is the first DC coefficient of the corresponding color channel C, ωₘₐₓ is the maximum DC coefficient, max(S_{C}) is the first maximum singular value in the first singular value matrix S_{C} of the corresponding color channel C, and max(S_{g}) is the second maximum singular value in the second singular value matrix S_{g}.

In the construction of the compensation coefficients, the maximum singular values of the first singular value matrix S_{C} and the second singular value matrix Sg are selected. These maximum singular values can effectively capture the main lighting information in the image, thereby achieving compensation and correction of the lighting. The construction of the compensation coefficients is based on the singular values, so as to maintain the structural characteristics and visual consistency of the original image while enhancing the image brightness.

In more detail, such as the three color channels R, G, and B, compensation weights of each of the color channels in the spatial domain are first adjusted to compensate for the illumination issue of the blood cell image while avoiding the use of only a single weight. Furthermore, the highest mean value (i.e., the maximum mean value) among the three color channels is used as a reference to calculate the adaptive compensation weights for the other two color channels, that is, to calculate the ratio between the maximum mean value and the mean value of each of the color channels (i.e., μₘₐₓ/μ_{c}).

However, only using the relationship between the color channels in the spatial domain is insufficient to achieve accurate compensation. Since the DC coefficient directly corresponds to the brightness of the image, the ratio between the maximum DC coefficient of the three color channels and the DC coefficient of each of the color channels (i.e., ωₘₐₓ/ω_{c}) is also used to construct the compensation coefficient. This compensation strategy combines information from the spatial domain and the frequency domain, achieves accurate correction of illumination changes, and improves the consistency of brightness and contrast of the enhanced image.

That is, by using the two ratios μₘₐₓ/μ_{c} and ωₘₐₓ/ω_{c}, the global distribution of the three color channels can be automatically adjusted to be close to a consistent distribution. Finally, the illumination of the blood cells is adjusted by the ratio of max(S_{g})/max(S_{C}) to obtain a result close to a normal distribution. If the image is darker, the value of max(S_{g})/max(S_{C}) will be greater than 1; conversely, if the image is brighter, the value of max(S_{g})/max(S_{C}) will be less than 1.

Step S143 includes: respectively applying the plurality of compensation coefficients to the plurality of first singular value matrices to obtain a plurality of first compensated singular value matrices.

Step S144 includes: respectively replacing the plurality of first singular value matrices in the plurality of first DCT coefficient matrices by the plurality of first compensated singular value matrices to obtain a plurality of compensated DC coefficients as the plurality of compensated DC characteristic information.

Steps S143 and S144 can be represented by the following formula:

$${𝒟}_{{c}_{α}} = {ℒ}_{c} ( {ζ}_{c} \times {𝒮}_{c} ) {ℛ}_{c}^{T} , c ∈ \{ R , G , B \} .$$

The compensation coefficients of this embodiment show the correlation between the three color channels in the spatial domain and the DCT domain, as well as the correlation between the colored image and the Gaussian distribution. Therefore, the compensation coefficients are multiplied by the eigenvalues in the first singular value matrix S_{C}, and multiplied by the left singular vector [symbol] _{c} and the right singular vector matrix

$${ℛ}_{C}^{T}$$

to update the first DCT coefficient matrix.

Step S15 includes: restoring the plurality of compensated DC characteristic information to a plurality of compensated frequency domain information, and performing an inverse conversion procedure on the plurality of compensated frequency domain information to obtain a plurality of second color channel images respectively corresponding to the plurality of color channels. In this step, the first DC coefficients of the plurality of first DCT coefficient matrices can be replaced by the compensated DC coefficients to obtain a plurality of third DCT coefficient matrices as the compensated frequency domain information. The inverse conversion procedure is a two-dimensional inverse discrete cosine transform (IDCT) procedure that is used to convert the plurality of third DCT coefficient matrices from the frequency domain to the spatial domain, so as to obtain the second color channel images. The inverse conversion procedure is as shown in the following equation:

[symbol]

_{c}_{ᵤ}=2DIDCT( [symbol] _{c}_{ₐ}).

Here, W_{Ca} is the second color channel image of the color channel C, and 2DiDCT is a two-dimensional inverse discrete cosine transform operation. That is to say, the image enhancement method of the present disclosure is practically a compensation algorithm using SVD in the cosine domain (CSVDC) procedure that can obtain a more optimized image by reconstructing the original image. Because these changes are linear transformations, they will not destroy the strong compression energy structure of the DCT coefficients, thereby retaining the structure of the blood cell image.

Step S16 includes: combining the plurality of second color channel images to generate an enhanced blood cell image.

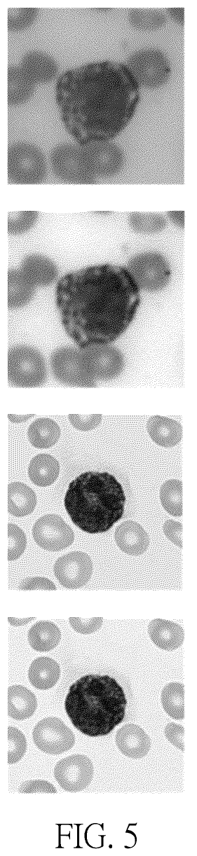

Referring to FIG. 5, FIG. 5 sequentially shows a basophil image of a Raabin-WBC dataset, the basophil image of the Raabin-WBC dataset processed by the image enhancement method of the present disclosure, a basophil image of a PBC_dataset_normal_DIB dataset, and the basophil image of the PBC_dataset_normal_DIB dataset processed by the image enhancement method of the present disclosure. As shown in FIG. 5, the brightness of the first basophil image is higher. However, the image processed by the image enhancement method of the present disclosure has a more accurate appearance, and the three color channels of the image are close to standard distribution. Similarly, the basophil image of the PBC_dataset_normal_DIB dataset and the image processed by the image enhancement method of the present disclosure also have the same trend. That is to say, the image enhancement method for blood cell images provided by the present disclosure can linearly adjust the values of the three color channels, eliminate the influence of illumination changes, and restore the color of an actual white blood cell.

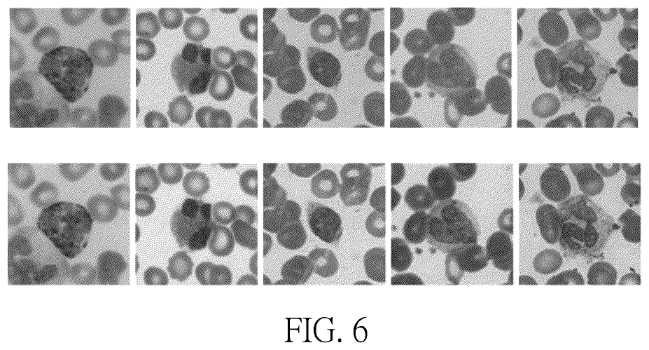

Referring to FIG. 6, FIG. 6 shows a plurality of WBC images with different backgrounds and images processed by the image enhancement method of the present disclosure. The five upper original WBC images in FIG. 6 have different backgrounds. However, after using the image enhancement method of the present disclosure, as shown in the five lower enhanced images, the three WBC color channels can be adaptively changed and the background of the WBC images can be adjusted to have the standard illumination distribution. In addition, the color of the white blood cells is further improved to match the actual color of the white blood cells. In addition, the image enhancement method of the present disclosure can further restore color and characteristics of the actual white blood cells. The enhanced WBC images assist the deep learning model to extract better characteristics for WBC recognition.

Five types of WBC are further used as below to evaluate the effectiveness of the image enhancement method for blood cell images of the present disclosure, and reference is made to the following Table 1.

TABLE 1

| | Mean recognition rate (%) | | | | |
|---|---|---|---|---|---|
| | | | | | The |
| | Original | | | | present |
| Model used | image | ASVDF | ASVDW | AHOSVD | disclosure |
| VGG-16 | 98.74 | 97.18 | 97.70 | 97.79 | 99.35 |
| ResNet | 93.17 | 94.30 | 85.62 | 88.37 | 96.99 |
| GoogLeNet | 93.03 | 90.01 | 91.16 | 91.31 | 98.45 |

In Table 1, recognition rates of the image enhancement method of the present disclosure is compared with recognition rates of existing image enhancement methods, such as adaptive singular value decomposition in Fourier domain (ASVDF), adaptive singular value decomposition in the wavelet domain (ASVDW), and adaptive higher-order singular value decomposition (AHOSVD). The average recognition rates in Table 1 confirm the effectiveness of the image enhancement method for blood cell images provided by the present disclosure. Table 1 shows that, by using the VGG16 model, the average recognition rate of the WBC image compensated by the image enhancement method of the present disclosure is 0.61%, 2.17%, 1.65%, and 1.56% higher than that of the original image, ASVDF image, ASVDW image, and AHOSVD image, respectively. By using ResNet, the average recognition rate of the WBC image compensated by the image enhancement method of the present disclosure is 3.82%, 2.69%, 11.37%, and 8.62% higher than that of the original image, ASVDF image, ASVDW image, and AHOSVD image, respectively. By using the GoogLeNet model, the average recognition rate of the WBC image after compensation by the image enhancement method of the present disclosure is 5.42%, 8.44%, 6.84%, and 7.14% higher than the original image, ASVDF image, ASVDW image, and AHOSVD image, respectively. The average recognition rate results further confirm that the color of white blood cells is an important characteristic for white blood cell identification. However, the image enhancement method of the present disclosure not only uniformly increases the contrast between the background and the WBC, but also retains the color of the WBC. Therefore, in identifying blood cell images, it is beneficial to use the image enhancement method of the present disclosure to pre-process the image before using the deep learning model to extract characteristics.

### BENEFICIAL EFFECTS OF THE EMBODIMENTS

One of the beneficial effects of the present disclosure is that, the image enhancement system and the image enhancement method for blood cell images provided by the present disclosure utilize the singular value decomposition processing method in the cosine domain to improve the quality of blood cell images in the preprocessing step. Experimental results based on the currently available data set show that the enhanced images significantly improve accuracy and stability during the training process of the deep learning model.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An image enhancement system for blood cell images, comprising:
a processing device configured to perform following procedures on a blood cell image to be processed:
decomposing the blood cell image to be processed into a plurality of first color channel images corresponding to a plurality of color channels;
performing a conversion procedure on the plurality of first color channel images and a predetermined brightness distribution of the blood cell image to be processed to obtain a plurality of first frequency domain information and second frequency domain information;
retrieving a plurality of first direct-current (DC) characteristic information from the plurality of first frequency domain information, and retrieving a second DC characteristic information from the second frequency domain information, respectively;
performing a decomposition procedure on the plurality of first DC characteristic information and the second DC characteristic information to obtain a plurality of first brightness characteristic information and second brightness characteristic information;
based on the plurality of first color channel images, the plurality of first DC characteristic information, the plurality of first brightness characteristic information, and the second brightness characteristic information, performing a brightness compensation procedure on the first brightness characteristic information in the plurality of first DC characteristic information to obtain a plurality of compensated DC characteristic information;
restoring the plurality of compensated DC characteristic information to a plurality of compensated frequency domain information, and performing an inverse conversion procedure on the plurality of compensated frequency domain information to obtain a plurality of second color channel images respectively corresponding to the plurality of color channels; and
combining the plurality of second color channel images to generate an enhanced blood cell image.

2. The image enhancement system according to claim 1, wherein the predetermined brightness distribution is a Gaussian template of the blood cell image to be processed, the conversion procedure is a two-dimensional discrete cosine transform (DCT) procedure, the plurality of first frequency domain information are a plurality of first DCT coefficient matrices corresponding to the plurality of color channels, and the second frequency domain information is a second DCT coefficient matrix corresponding to the Gaussian template.

3. The image enhancement system according to claim 2, wherein the plurality of first DC characteristic information are a plurality of first DC coefficients extracted from the plurality of first DCT coefficient matrices, and the second DC characteristic information is a second DC coefficient extracted from the second DCT coefficient matrix.

4. The image enhancement system according to claim 3, wherein the decomposition procedure is a singular value decomposition procedure, the first brightness characteristic information is a plurality of first singular value matrices decomposed from the plurality of first DCT coefficient matrices, and the second brightness characteristic information is a second singular value matrix decomposed from the second DCT coefficient matrix.

5. The image enhancement system according to claim 4, wherein the brightness compensation procedure includes:
respectively calculating and comparing a plurality of mean values of the plurality of first color channel images to obtain a maximum mean value;
acquiring and comparing a plurality of DC coefficients of the plurality of first DCT coefficient matrices to obtain a maximum DC coefficient;
calculating a plurality of compensation coefficients corresponding to the color channels based on the plurality of mean values, the maximum mean value, the plurality of DC coefficients, the maximum DC coefficient, the plurality of first singular value matrices, and the second singular value matrix;
respectively applying the plurality of compensation coefficients to the plurality of first singular value matrices to obtain a plurality of first compensated singular value matrices; and
respectively replacing the plurality of first singular value matrices in the plurality of first DCT coefficient matrices by the plurality of first compensated singular value matrices to obtain a plurality of compensated DC coefficients as the plurality of compensated DC characteristic information.

6. The image enhancement system according to claim 5, wherein each of the plurality of compensation coefficients is expressed by the following equation of:
$${ζ}_{c} = \frac{{μ}_{max}}{{μ}_{c}} \times \frac{{ω}_{max}}{{ω}_{c}} \times \frac{max ( {𝒮}_{𝒢} )}{max ( {𝒮}_{c} )} ;$$
and wherein C is one of the plurality of color channels, ζ_{C} is a corresponding compensation coefficient, μ_{C} is a corresponding mean value, μₘₐₓ is the maximum mean value, ω_{C} is a corresponding first DC coefficient, ωₘₐₓ is the maximum DC coefficient, max(S_{C}) is a first maximum singular value in a corresponding first singular value matrix, and max(S_{g}) is a second maximum singular value in the second singular value matrix.

7. The image enhancement system according to claim 5, wherein the procedure of restoring the plurality of compensated DC characteristic information to the plurality of compensated frequency domain information includes replacing the plurality of first DC coefficients of the plurality of first DCT coefficient matrices by the plurality of compensated DC coefficients to obtain a plurality of third DCT coefficient matrices as the plurality of compensated frequency domain information.

8. The image enhancement system according to claim 7, wherein the inverse conversion procedure is an inverse discrete cosine transform (IDCT) procedure for converting the plurality of third DCT coefficient matrices from a frequency domain to a spatial domain to obtain the plurality of second color channel images.

9. An image enhancement method for blood cell images, comprising:
configuring a processing device to perform the following procedures on a blood cell image to be processed:
decomposing the blood cell image to be processed into a plurality of first color channel images corresponding to a plurality of color channels;
performing a conversion procedure on the plurality of first color channel images and a predetermined brightness distribution of the blood cell image to be processed to obtain a plurality of first frequency domain information and second frequency domain information;
retrieving a plurality of first direct-current (DC) characteristic information from the plurality of first frequency domain information, and retrieving a second DC characteristic information from the second frequency domain information, respectively;
performing a decomposition procedure on the plurality of first DC characteristic information and the second DC characteristic information to obtain a plurality of first brightness characteristic information and second brightness characteristic information;
based on the plurality of first color channel images, the plurality of first DC characteristic information, the plurality of first brightness characteristic information, and the second brightness characteristic information, performing a brightness compensation procedure on the first brightness characteristic information in the plurality of first DC characteristic information to obtain a plurality of compensated DC characteristic information;
restoring the plurality of compensated DC characteristic information to a plurality of compensated frequency domain information, and performing an inverse conversion procedure on the plurality of compensated frequency domain information to obtain a plurality of second color channel images respectively corresponding to the plurality of color channels; and
combining the plurality of second color channel images to generate an enhanced blood cell image.

10. The image enhancement method according to claim 9, wherein the predetermined brightness distribution is a Gaussian template of the blood cell image to be processed, the conversion procedure is a two-dimensional discrete cosine transform (DCT) procedure, the plurality of first frequency domain information are a plurality of first DCT coefficient matrices corresponding to the plurality of color channels, and the second frequency domain information is a second DCT coefficient matrix corresponding to the Gaussian template.

11. The image enhancement method according to claim 10, wherein the plurality of first DC characteristic information are a plurality of first DC coefficients extracted from the plurality of first DCT coefficient matrices, and the second DC characteristic information is a second DC coefficient extracted from the second DCT coefficient matrix.

12. The image enhancement method according to claim 11, wherein the decomposition procedure is a singular value decomposition procedure, the first brightness characteristic information is a plurality of first singular value matrices decomposed from the plurality of first DCT coefficient matrices, and the second brightness characteristic information is a second singular value matrix decomposed from the second DCT coefficient matrix.

13. The image enhancement method according to claim 12, wherein the brightness compensation procedure includes:
respectively calculating and comparing a plurality of mean values of the plurality of first color channel images to obtain a maximum mean value;
acquiring and comparing a plurality of DC coefficients of the plurality of first DCT coefficient matrices to obtain a maximum DC coefficient;
calculating a plurality of compensation coefficients corresponding to the color channels based on the plurality of mean values, the maximum mean value, the plurality of DC coefficients, the maximum DC coefficient, the plurality of first singular value matrices, and the second singular value matrix;
respectively applying the plurality of compensation coefficients to the plurality of first singular value matrices to obtain a plurality of first compensated singular value matrices; and
respectively replacing the plurality of first singular value matrices in the plurality of first DCT coefficient matrices by the plurality of first compensated singular value matrices to obtain a plurality of compensated DC coefficients as the plurality of compensated DC characteristic information.

14. The image enhancement method according to claim 13, wherein each of the plurality of compensation coefficients is expressed by the following equation of:
$${ζ}_{c} = \frac{{μ}_{max}}{{μ}_{c}} \times \frac{{ω}_{max}}{{ω}_{c}} \times \frac{max ( {𝒮}_{𝒢} )}{max ( {𝒮}_{c} )} ;$$
and wherein C is one of the plurality of color channels, ζ_{C} is a corresponding compensation coefficient, u_{C} is a corresponding mean value, μₘₐₓ is the maximum mean value, ω_{C} is a corresponding first DC coefficient, ωₘₐₓ is the maximum DC coefficient, max(S_{C}) is a first maximum singular value in a corresponding first singular value matrix, and max(S_{g}) is a second maximum singular value in the second singular value matrix.

15. The image enhancement method according to claim 13, wherein the procedure of restoring the plurality of compensated DC characteristic information to the plurality of compensated frequency domain information includes replacing the plurality of first DC coefficients of the plurality of first DCT coefficient matrices by the plurality of compensated DC coefficients to obtain a plurality of third DCT coefficient matrices as the plurality of compensated frequency domain information.

16. The image enhancement method according to claim 15, wherein the inverse conversion procedure is an inverse discrete cosine transform (IDCT) procedure for converting the plurality of third DCT coefficient matrices from a frequency domain to a spatial domain to obtain the plurality of second color channel images.
